(19) United States
(12) Patent Application Publication
(10) Pub. No.: US 2003/0061493 A1
(43) Pub. Date: Mar. 27, 2003

(54) Portable voice encrypter

(76) Inventors: Michael F. Angelo, Houston, TX (US); Manuel Novoa, Houston, TX (US); Sompong P. Olarig, Pleasonton, CA (US)

Correspondence Address: CONLEY ROSE, P.C., P. O. BOX 3267, HOUSTON, TX, 77253-3267, US

(21) Appl. No.: 09/961,603

(22) Filed: Sep. 24, 2001

(51) Int. Cl. H04M 1/70

(52) U.S. Cl. 713/189

(57) ABSTRACT

A portable electronic device (e.g., a PDA) receives voice or other types of audio or even other types of media (e.g., video) and digitize, encrypt and transmit the voice stream to an external device (e.g., another portable electronic device) in real-time so that a real-time, two-way communication can occur. Each portable electronic device preferably includes a CPU executing security software to perform the encryption and decryption functions. The devices may communicate with each other via a standard telephone system or other type of communication media.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to the secured transmission of information, such as audio, video or a combination of audio and video. More particularly, the invention relates to a portable electronic device capable of encrypting and sending audio to a destination device. Still more particularly, the invention relates to the real-time encryption of audio using a dynamically variable session key.

2. Background of the Invention

Numerous innovations have been made in the computer arts. For example, wireless portable devices such as laptop computers, handheld personal data assistants (“PDAs”), wireless email devices, and the like have made it easy to perform various computer tasks (e.g., word processing, email, etc.) virtually anywhere. Improvements in miniaturization have resulted in portable computer devices that are very small with some being no larger than a common pager.

With the advent of publicly accessible networks, such as the Internet, tremendous amounts of information can be, and are, quickly and easily transmitted across the world. The ability to readily transmit information creates a concern for the security of the information being transmitted. That is, there is a need to secure the information in some fashion so that the information cannot be intercepted and accessed by an unauthorized entity, or at least not easily accessed by an unauthorized entity. Many techniques for encrypting data transmitted over a network have been proposed and implemented. One well known technique involves encrypting a data file with an encryption “key” and then decrypting the file at the receiving location using the same or related key.

The telephone remains the most widely used medium of communication. The telephone is simple to use and incurs a fairly low cost. Using a telephone, a user's voice is transmitted through the telephone wires, switches, etc. to a destination telephone where the voice is converted back to an audible version. Conventional telephones, however, typically do not provide a means to provide users a secured environment in which to have a conversation. Despite the advantages such a telephone would provide, no such device is known to exist.

### BRIEF SUMMARY OF THE INVENTION

The problems noted above are solved in large part by a portable electronic device (e.g., a PDA) which can receive voice or other types of audio or even other types of media (e.g., video) and digitize, encrypt and transmit the voice stream to an external device (e.g., another portable electronic device) in real-time so that a real-time, two-way communication can occur. The devices may communicate with each other via a standard telephone system or other type of communication media. Each portable electronic device preferably includes a CPU executing security software to perform the encryption and decryption functions. Each device preferably also includes a microphone for a person to speak into and a speaker to provide audio to the user. The device may be provided in the form of an adapter that mates with, or otherwise couples, to a telephone receiver.

As a user speaks into the device, the user's voice is digitized and encrypted and transmitted to a user of another of such devices in real-time (i.e., as it is received). In this way, a two-way, secured conversation can be done between users of the devices. To increase security even further, the devices may initiate a communication by negotiating a “session” key, which may be a random number generated by one of the devices. Further still, the devices may dynamically change the session key during a conversation.

### BRIEF DESCRIPTION OF THE DRAWINGS

For a detailed description of the preferred embodiments of the invention, reference will now be made to the accompanying drawings in which:

FIG. 1 illustrates two portable electronic devices communicating with one another in a secured, encrypted fashion;

FIG. 2 shows more detail regarding the portable electronic devices; and

FIG. 3 depicts the basic processes, including real-time encryption, involved in the communication between two devices.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. The term “real time encryption” is intended to an event that occurs coincident with, or nearly coincident with, another event. In the context of this disclosure, encryption of an audio stream that occurs in “real time” means that the audio stream is encrypted as it is being received without such a delay to interfere with the usefulness of the audio stream. To the extent that any term is not specially defined in this specification, the intent is that the term is to be given its plain and ordinary meaning.

### DETAILED DESCRIPTION OF THE PREFERRED EMBODIMENTS

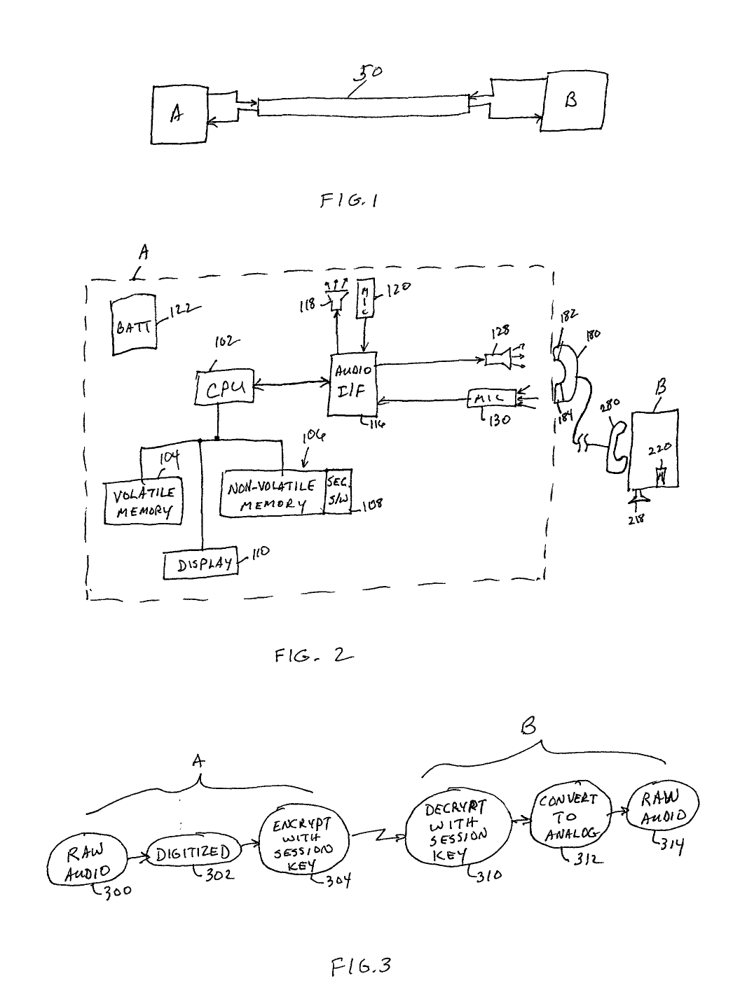

Referring now to the figures, FIG. 1 is presented to broadly illustrate the principle underlying the preferred embodiments. FIG. 1 shows two electronic devices A and B in communication with one another via a communication link 50. Using the devices, two people can talk to each other with the devices transmitting encrypted voice streams in real time. That is, device A can encrypt a person's voice as the voice is received and transmit an encrypted voice stream over link 50 to device B where it is decrypted and played for the other user. Of course, device B permits the other user to do the same thing. Accordingly, a two-way, real time encrypted voice conversation can occur between the users of devices A and B. It should be recognized that the embodiments described herein are not limited to voice signals, but apply generally to any type of audio as well as other types of information such as video or a combination of audio and video.

FIG. 2 shows one suitable embodiment of devices A, B. As shown, devices A and B preferably comprise a portable electronic device such as a personal data assistant (“PDA”). The communication link 50 in FIG. 1 preferably includes a telephonic communication link such as a conventional system. As such, telephones 180 and 280 are used to couple the PDAs A and B to the telephone line.

Each PDA A, B preferably includes a central processing unit (“CPU”) 102, a volatile memory device 104, a non-volatile memory device 106, a display 110, an audio interface 116, speakers 118 and 128 and microphones 120 and 130. The PDA preferably is a portable device and thus may include a battery 122 for power. The CPU 102 generally controls the operation of the PDA and can access memories 106 and 106 as well as provide information to display 110 to be presented to the user. Most PDAs include a stylus (not shown) which a person uses as an input device to enter information and control the operation of the PDA. The audio interface 116 couples the speakers and microphones to the CPU and may also include a digital-to-analog converter (“DAC”) and an analog-to-digital converter (“ADC”) which are controlled by CPU 102. The PDA architecture shown in FIG. 2 is only intended to be exemplary and thus can be modified as desired. Other components may be provided as desired.

Referring still to FIG. 2, each PDA can function to couple to a telephone 180, 280 and to provide encryption/decryption capabilities. Security software 108 preferably stored in non-volatile memory 106 can be executed by CPU 102 to provide the functionality described herein. Each PDA may be made to be mated with, or otherwise couple to, a standard telephone receiver 180, 280 so that speaker 128 and microphone 130 are audibly coupled to the microphone 182 and speaker 184 of the telephone. When an operator of device A wishes to initiate a call to a user of device B, the operator of device A enters device B's phone number or other identifying information. Once the call is placed, devices A and B can communicate with each other in an encrypted or unencrypted manner. The default mode may unencrypted communication, as with standard telephone calls. Alternatively, encrypted communication can be the default communication mode. The users can switch between encrypted and unencrypted communication whenever desired by activating an input control to their associated PDA A or B. The input control may be a “tap” of a stylus on a selectable icon on display 110. The CPU 102 would then respond to that tap by switching communication modes.

In general, a person using PDA A speaks into microphone 120, which converts the voice to an electrical signal in accordance with known techniques. The voice electrical signal is digitized and encrypted (if the encrypted communication mode is selected) in real-time by PDA A and played back, in encrypted form, over speaker 128. The encrypted sound from speaker 128 is received by the microphone 182 of telephone 180 which, in turn, transmits the encrypted signal through the telephone system to the associated PDA B. Because the original audio signal has been encrypted, it is unintelligible when played back through the receiving PDA B. If desired, the voice electrical signal from microphone 120 may be compressed by CPU 102 and/or audio interface 116 prior to being encrypted. Any suitable encryption technique, such as MPEG3, can be used in this regard. Further still, the encrypted voice signal from audio interface 116 can be provided to PDA B via a modem instead of using speaker 128. Alternatively, the encrypted voice signal can be provided to the base unit of telephone 180 (not shown) via an electrical cable.

The receiving PDA B reverses the process by real-time decrypting the transmission and playing it back through the PDA's speaker 218 (which corresponds functionally to speaker 118 in PDA A). A person using PDA B can speak into its microphone 220. PDA B then encrypts the voice stream and provides it through telephone 280 to telephone 180 where the encrypted voice stream is played back through the telephone's speaker 184. Encrypted sound from the telephone 180 is received by the PDA's microphone 130, decrypted by the PDA's CPU 102 and played in real-time in unencrypted form through speaker 118 to the user of PDA A. In this manner, a secure, two-way, real-time encrypted conversation can occur. One or ordinary skill in the art will readily understand that the encrypted, real-time communication can be half duplex or full duplex.

Any suitable type of real-time encryption technique can be used. Preferably an encryption technique that uses a “session” key is implemented. A session key is a value known to PDAs A and B and used to encrypt and decrypt the audio streams by both devices. For security, the session's key preferably is known only to devices A, B and noone else. Creation of the session key preferably occurs when a communication between A and B is initiated or when the encrypted communication mode is entered.

There are a number of well known ways in which a secured session key can be created. For instance, when device A initiates a call to device B, device A generates a random number using any one of a variety of conventional random number generation techniques. That random number comprises the session key. The session key preferably is communicated to device B in a secure way. This can be accomplished, for instance, by encrypting the session key with an encryption key known a priori only to devices A and B. Device A can then send the encrypted session key to device B, which decrypts the message to recover the key.

The session key can also be communicated to device B by device A encrypting the session key with device A's “private” key and device B's “public” key. Public key/private key encryption is a well known technique involving a pair of keys—a public key and a private key. The keys generally are related to each other via a mathematical formula. A message can be encrypted with one of the keys in such a way that it can only be decrypted with the corresponding other key. Generally, a private key is kept in a secured location, while the corresponding public key is available to everyone. In the context of synchronizing the session key between PDAs A and B, PDA A's CPU 102 encrypts the session key twice—once with the PDA A's private key and another time with PDA B's public key. Then, PDA B decrypts the message with PDA A's public key and then again with PDA B's private key. Each PDA A and B may access any commonly known on-line service to obtain the public key of the other device.

Once PDAs A and B are synchronized to the same session key, encrypted real-tine voice communications can begin. Each device A and B, via its CPU executing security software 108, encrypts the voice streams using the session key in accordance with known techniques. The preferred process is depicted in FIG. 3, which will now be described in conjunction with FIG. 2. As shown in FIG. 3, PDA A performs processes 300, 302 and 304, while PDA B performs processes 310, 312, and 314. In process 300, PDA A receives raw (unencrypted, analog audio) via microphone 120 which converts the audio signal to an electrical analog signal and provides that signal to audio interface 116. In process 302, the audio interface, under control by CPU 102, digitizes the audio analog signal. The digitized audio stream is then encrypted by CPU 102 using the session key, converted to an analog signal and transmitted through speaker 128 and telephone 180 to PDAB.

PDA B receives the encrypted audio analog stream and decrypts the stream using the session key (process 310). Then, PDA B converts the decrypted signal to an analog signal in process 312 and provides the raw audio (process 314) through telephone 280 to the person using PDA B. Of course, the reciprocal process occurs for PDA B to encrypt and send audio streams to PDA A.

If desired for increased security, the session key can be dynamically changed during a conversation. By “dynamically changed” it is meant that the session key is changed at least once after PDAs A and B are initially synchronized to the session key. Any one of a variety of techniques can be used to change the session key. For example, PDAs A and B may be programmed to automatically negotiate a new session key at predetermined time intervals (e.g., once per minute). Alternatively, the session key itself may encode information that identifies how and when the key is to be renegotiated. For instance, the session key may specify the time at which a new key is to be negotiated. By dynamically changing the session key, even if an unauthorized entity somehow obtain the current session key, thereby compromising the security of the encrypted audio stream, the audio stream would again become secure the next time the session key was changed.

Further still, as noted above, the PDAs A and B provide the operators the ability to switch in and out of encrypted communication mode. The same session key may used for each subsequent entry of the encrypted communication mode, or a different session key may be negotiated each time the encrypted communication mode is entered.

As described above with regard to FIG. 2, PDAs A and B are audibly coupled to telephone receivers 180 and 280. Alternatively, each PDA may be incorporated with a standard RJ11 connector to permit the PDA to be connected directly to a telephone line. In this case, speaker 128 and microphone 130 would be unnecessary. Further still, the communication link 50 shown in FIG. 1 may comprise a network, such as the Internet with the PDAs effectively being Internet telephones with encryption capabilities.

Further still, the real-time encryption capability depicted in FIG. 2 can be incorporated into a standard telephone set. An input control, such as a button, can be included on the telephone to permit a user to proceed with the conversation in a secured environment. Pressing the button would cause the telephone to create and encrypt a session key that is sent to the receiving telephone, which would also be equipped to send and receive encrypted audio. The receiving telephone preferably would detect the presence of an encrypted session key message and the process would continue on from that point as described above.

The communication link 50 described above includes the telephone system. However, it should be recognized that other types of communication media can be used. For example, the link may comprise any type of digital or analog network including electrical conductors, fiber optics, or wireless. In a wireless communication link, radio frequency (“RF”) or infra red (“IR”) can be used. For instance, devices A and B may include IR ports instead of speaker 128 and microphone 130. Such IR ports are well known in the PDA arts today.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A portable electronic device, comprising:
a CPU;
a first audio output device coupled to said CPU; and
a first audio input device coupled to said CPU;
said first audio input device receives an audio signal which is digitized and encrypted for transmission to an external device, said encryption occurring in real time.

2. The portable electronic device of claim 1 wherein said first audio input device comprises a microphone.

3. The portable electronic device of claim 2 wherein said first audio output device comprises a speaker.

4. The portable electronic device of claim 3 further including a second audio output device coupled to said CPU and which is adapted to provide audio through a telephone to said external device.

5. The portable electronic device of claim 4 wherein said second audio output device comprises a speaker.

6. The portable electronic device of claim 3 further including a second audio input device coupled to said CPU and which is adapted to receive audio from said external device through a telephone.

7. The portable electronic device of claim 6 wherein said second audio input device comprises a microphone.

8. The portable electronic device of claim 1 further including a second audio output device coupled to said CPU and which is adapted to provide audio through a telephone to said external device.

9. The portable electronic device of claim 1 further including a second audio input device coupled to said CPU and which is adapted to receive audio from said external device through a telephone.

10. The portable electronic device of claim 1 further including an infra-red output device coupled to said CPU and which is adapted to transmit audio signals to said external device.

11. The portable electronic device of claim 1 further including an infra-red input device coupled to said CPU and which is adapted to receive audio signals from said external device.

12. The portable electronic device of claim 1 wherein said audio signal comprises voice and said portable electronic device receives an encrypted voice stream from said external device and decrypts said encrypted voice stream so that a real time, two voice conversation can be performed between said portable electronic device and said external device.

13. The portable electronic device of claim 1 wherein said CPU uses a session key to encrypt said audio signal, said session key is synchronized between said portable electronic device and said external device.

14. The portable electronic device of claim 13 wherein said session key is changed during a transmission by said CPU.

15. The portable electronic device of claim 13 wherein said portable electronic device comprises a personal data assistant.

16. The portable electronic device of claim 1 wherein said portable electronic device comprises a personal data assistant.

17. A method for a secured, two-way, real-time audio communication between two electronic devices, comprising:
(a) receiving an unencrypted, analog audio signal;
(b) digitizing said unencrypted, analog audio signal;
(c) encrypting said unencrypted, analog audio signal as said unencrypted, analog audio signal is received to produce an encrypted audio stream; and
(d) transmitting said encrypted audio stream to one of said electronic devices.

18. The method of claim 17 further including receiving said encrypted audio stream and decrypting said encrypted audio stream as said unencrypted, analog audio signal is received.

19. The method of claim 17 wherein (c) uses a session key synchronized between said electronic devices.

20. The method of claim 19 wherein said session key is changed during a communication between said electronic devices.

21. A two-way secured communication system, comprising: at least two electronic devices, each electronic device including:
a CPU;
a first audio output device coupled to said CPU; and
a first audio input device coupled to said CPU;
said first audio input device receives an audio signal which is digitized and encrypted for transmission to the other electronic device, said encryption occurring in real time;
said electronic devices communicating in real-time with one another over a communication link.

22. The system of claim 21 wherein said first audio input device comprises a microphone.

23. The system of claim 22 wherein said first audio output device comprises a speaker.

24. The system of claim 23 further including a second audio output device coupled to said CPU and which is adapted to provide audio through a telephone to the other of said electronic devices.

25. The system of claim 24 wherein said second audio output device comprises a speaker.

26. The system of claim 23 further including a second audio input device coupled to said CPU and which is adapted to receive encrypted audio from the other of said electronic devices through a telephone.

27. The system of claim 26 wherein said second audio input device comprises a microphone.

28. The system of claim 21 further including a second audio output device coupled to said CPU and which is adapted to provide audio through a telephone to the other of said electronic devices.

29. The system of claim 21 further including a second audio input device coupled to said CPU and which is adapted to receive audio from the other of said electronic devices through a telephone.

30. The system of claim 21 further including an infra-red output device coupled to said CPU and which is adapted to transmit audio signals to the other of said electronic devices.

31. The system of claim 21 further including an infra-red input device coupled to said CPU and which is adapted to receive audio signals from the other of said electronic devices.

32. The system of claim 21 wherein said audio signal comprises voice and one of said electronic devices receives an encrypted voice stream from the other of said electronic devices and decrypts said encrypted voice stream so that a real time, two voice conversation can be performed between said electronic devices.

33. The system of claim 21 wherein said CPU uses a session key to encrypt said audio signal, said session key is synchronized between said electronic devices.

34. The system of claim 33 wherein said session key is changed during a transmission by said CPU.

35. The system of claim 33 wherein at least one of said electronic devices comprises a personal data assistant.

36. The system of claim 21 wherein at least one of said electronic devices comprises a personal data assistant.

37. The system of claim 21 wherein said communication link includes a telephone system.

38. An electronic device, comprising:
a CPU;
a microphone coupled to said CPU;
a speaker coupled to said CPU;
an input control device coupled to said CPU; and
an interface to a communication link to an external device;
said input control device being used to initiate a call to said external device over said communication link and said input control device being used to select between an unencrypted communication mode and an encrypted communication mode; and
said microphone receiving an audio signal which is digitized and encrypted for transmission to an external device, said encryption occurring in real time.

39. The electronic device of claim 38 wherein said CPU uses an agreed upon session key to encrypt and decrypt communications between said electronic device and said external device.

40. The electronic device of claim 39 wherein said input control can be used to switch between said unencrypted and encrypted communication modes.

41. The electronic device of claim 40 wherein a different session key is used each time the encrypted communication mode is entered.

42. The electronic device of claim 38 wherein said CPU uses a private key associated with said electronic device and a public key associated with another electronic device to encrypt a session to send to said another electronic device, said session key is used to encrypt and decrypt communications between said electronic devices.

43. The electronic device of claim 42 wherein said electronic device accesses on-line service to obtain the public key associate with said another electronic device.
